(19) United States
(12) Patent Application Publication
(10) Pub. No.: US 2010/0283820 A1
(43) Pub. Date: Nov. 11, 2010

(54) Inkjet head assembly

(75) Inventors: Won Chul SIM, Seongnam (KR); Jae Woo JOUNG, Suwon (KR); Young Seuck Yoo, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/585,192

(22) Filed: Sep. 8, 2009

(30) Foreign Application Priority Data
May 7, 2009 (KR) 10-2009-0039640

(51) Int. Cl. B41J 2/175

(52) U.S. Cl. 347/85

(57) ABSTRACT

There is provided an inkjet head assembly. The inkjet head assembly includes an ink tank including a first storage part receiving ink, and a second storage part communicating with the first storage part through at least one through hole and maintaining a full ink level upon receiving ink from the first storage part, and an inkjet head connected to the second storage part by an ink supply path and ejecting ink upon receiving ink from the second storage part. The inkjet head assembly includes the ink tank supplying ink to the inkjet head and storing ink separately in the first storage part and the second storage part thereof, and the second storage part maintains a full ink level therein. Accordingly, deterioration in print quality can be minimized due to the second storage part attenuating pressure variations caused by ink movement when the inkjet assembly moves.

### CROSS-REFERENCE TO RELATED APPLICATIONS

This application claims the priority of Korean Patent Application No. 10-2009-0039640 filed on May 7, 2009, in the Korean Intellectual Property Office, the disclosure of which is incorporated herein by reference.

### BACKGROUND OF THE INVENTION

1. Field of the Invention

The present invention relates to an inkjet head assembly, and more particularly, to an inkjet head assembly achieving high print quality by minimizing pressure variations caused by ink movement occurring in a transfer operating system.

2. Description of the Related Art

Image forming apparatuses develop a black-and-white image or a color image on a recording medium, such as paper, according to an image signal. Examples of the image forming apparatuses include laser printers, inkjet printers, copy machines, multifunction printers, and fax machines. Representative image formation methods employed by the various image forming apparatuses include an electrophotographic method and an inkjet method. As for the electrophotographic method, an electrostatic latent image is produced on a photoconductor by scanning beams and is transferred onto a recording medium by attaching a developer to the photoconductor. As for the inkjet method, liquid ink is ejected onto the surface of a recording medium according to an image signal.

An inkjet image forming apparatus includes an inkjet head that ejects ink according to an image signal. The inkjet head prints letters or images on a recording medium by ejecting ink droplets onto the recording medium according to an image signal. The inkjet image forming apparatus is in wide use for printing operations since it generates relatively little noise during printing operations and forms fine ink droplets with high density.

One type of inkjet image forming apparatus includes an inkjet head receiving ink from an ink tank which is integrally or detachably attached thereto, a carriage scanning the inkjet head in a predetermined direction with respect to a recording medium, and a transfer unit transferring the inkjet head in a direction orthogonal to the predetermined direction (sub-scanning). The inkjet image forming apparatus forms an image by ejecting ink while scanning the inkjet head.

The inkjet head of the inkjet image forming apparatus may be classified into a shuttle type print head and a so-called array inkjet head. The shuttle type print head is spaced apart from the surface of a recording medium being transferred, and ejects ink while reciprocally moving in the transfer direction of a recording medium and an orthogonal direction thereto (the width direction of the recording medium). The array inkjet head has a length corresponding to the width of a recording medium and is capable of line printing. The array inkjet head can print one line at a time, thereby achieving high-speed printing.

The shuttle type inkjet head or the array type inkjet head receives ink from an ink tank that contains ink. When the inkjet head is transferred by the transfer unit during printing operations, pressure variations may be caused by the movement of ink within the ink tank. These pressure variations adversely affect the speed and volume of ink droplets being ejected, deteriorating print quality.

### SUMMARY OF THE INVENTION

An aspect of the present invention provides an inkjet head assembly achieving high print quality by minimizing pressure variations caused by ink movement during printing operations.

According to an aspect of the present invention, there is provided an inkjet head assembly including: an ink tank including a first storage part receiving ink, and a second storage part communicating with the first storage part through at least one through hole and maintaining a full ink level upon receiving ink from the first storage part; and an inkjet head connected to the second storage part by an ink supply path and ejecting ink upon receiving ink from the second storage part.

The through hole may have a diameter ranging from 1 mm to 10 mm, and the second storage part may have a volume of 10 cc or greater.

The ink supply path may include a filter.

The inkjet head may include an ink chamber temporarily storing ink supplied from the second storage part.

The inkjet head may include an inkjet path discharging ink supplied from the second storage part.

The first storage part may include a pneumonic port, and the first storage part may include an ink injection port.

The first storage part may include a sensor measuring an ink level. The sensor may be mounted to an upper portion or a side portion of the first storage part.

The sensor may include: a first sensor measuring a lower limit of an ink level in the first storage part; and a second sensor measuring an upper limit of the ink level in the first storage part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating an inkjet head assembly according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and sizes of elements may be exaggerated for clarity. Like reference numerals in the drawings denote like elements.

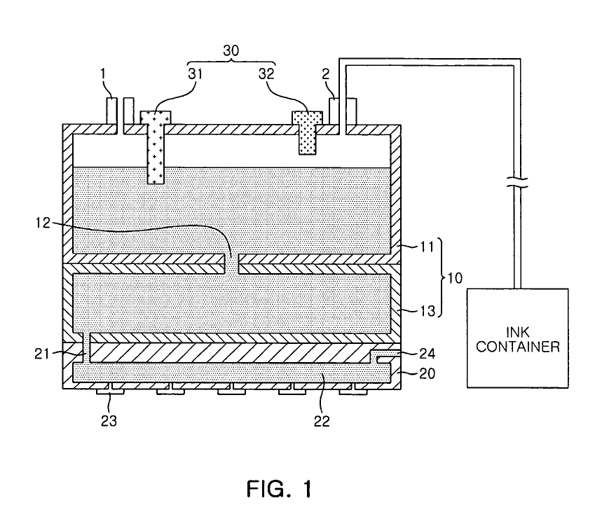

FIG. 1 is a schematic cross-sectional view illustrating an inkjet head assembly according to an exemplary embodiment of the present invention.

Referring to FIG. 1, an inkjet head assembly according to this embodiment includes an ink tank 10 containing ink, and an inkjet head 20 receiving ink from the ink tank and forming an image by ejecting the ink onto a recording medium.

Throughout the description of the present invention, the term “recording medium” refers not only to paper but also to various ink-receivable materials such as clothes, plastics, metal plates, ceramics, woods, and leathers.

The ink tank 10 includes a first storage part 11 receiving ink, and a second storage part 13 communicating with the first storage part 11 through at least one through hole 12. The second storage part 13 receives ink from the first storage part 11 and supplies it to the inkjet head 20. The second storage part 13 maintains a full ink level and supplies ink to the inkjet head with the full ink level maintained. Here, the full ink level means that the second storage part 13 is completely filled with ink.

The first storage part 11 and the second storage part 13 of the ink tank 10 are connected by at least one through hole 12, and the diameter of the through hole 12 is not limited, but may range from 1 mm to 10 mm, for example.

The inkjet head 20 is connected to the second storage part 13 through an ink supply path 21, and ejects ink upon receiving ink from the second storage part 13. A filter (not shown) may be formed in the ink supply path. Ink being supplied from an ink tank to an inkjet head needs to be maintained clean without foreign bodies such as dust. Foreign bodies such as dust may block a nozzle in the inkjet head, adversely affecting ink ejection.

The inkjet head 20 includes an ink chamber 22 formed at the upper side of the inkjet head 20 and temporarily storing ink supplied from the second storage part 13, and a plurality of nozzles 23 formed on a lower surface thereof and ejecting ink.

The inkjet head 20 includes an inkjet path 24 connected to one side of the inkjet head 20 and discharging ink from the ink chamber 22 to the outside.

An inkjet head assembly, when transferred by a transfer unit (not shown) for printing operations, is subject to pressure variations due to the movement of ink stored in an ink tank. This adversely affects the speed and volume of ink droplets being ejected by the inkjet head, thereby deteriorating print quality. However, according to the present invention, the ink tank 10 supplying ink to the inkjet head 20 is divided into the first storage part 11 and the second storage part 13, and the second storage part 13 connected directly to the inkjet head 20 operates while maintaining a full ink level. That is, when the inkjet head assembly moves, the second storage part 13 attenuates the pressure variations occurring due to ink movement in the first storage part 11, thereby minimizing deterioration in print quality.

The volume of the second storage part 13 is not limited but may be 10 cc or greater because the insufficient volume of the second storage part 13 may fail to attenuate the pressure variations within the first storage part 11 sufficiently.

An inkjet head receives ink from an ink tank. If the inkjet head is provided with an excessive amount of ink or is provided with ink when printing is not being performed, this may cause ink to undesirably come out of the surface of the inkjet head regardless of the status of printing operations. This phenomenon is called wetting. To prevent this wetting phenomenon, negative pressure needs to be created between the inkjet head and the ink tank so that ink only moves between the ink tank and the inkjet head when ink is ejected from the inkjet head.

Therefore, a pneumatic port 1 may be formed at the first storage part 11 in order to create negative pressure between the inkjet head 20 and the ink tank 10.

In addition, an ink injection port 2 may be formed at the first storage part 11 in order to inject ink to the first storage part 11 from an ink container when an ink level in the first storage part 11 drops below a predetermined ink level.

The operational process of the inkjet head assembly will now be described.

In general, an ink tank and an inkjet head in an inkjet head assembly may be formed integrally or separably. The separable inkjet head assembly is mounted to a transfer system (not shown) that can transfer it to a recording medium. First, the ink tank is mounted to the transfer system and then the inkjet head is coupled to the ink tank.

The inkjet head assembly mounted to the transfer system (not shown) moves along the print side of the recording medium, ejecting ink through a nozzle and thus forming an image.

At an early stage of ink supply, ink supplied to the inkjet head 20 may be discharged through the inkjet path 24 for a predetermined duration. This prevents ink containing bubbles from being supplied at the time of ink supply from the ink tank 10 to the inkjet head 20.

As described above, the ink tank 10 includes the first storage part 11 and the second storage part 13. Also, the second storage part 13, connected directly to the inkjet head 20, supplies ink to the inkjet head 20 with a full ink level maintained. Accordingly, pressure variations caused by ink movement are prevented from occurring when the inkjet head assembly is transferred for printing operations, thereby achieving a high print quality.

When an ink level in the first storage part 11 drops below a predetermined ink level in the process of forming an image, ink may be injected from the ink container through the ink injection port 2 formed in the first storage part 11.

Therefore, even if ink is supplied to the first storage part 11 and the second storage part 13 due to ink consumption for printing, pressure variations caused by this ink supply can be effectively attenuated.

According to this embodiment, the first storage part 11 may include a sensor measuring an ink level. In order to maintain the full ink level in the second storage part 13 receiving ink from the first storage part 11, it is important to maintain an ink level in the first storage part 11 at a predetermined level or higher. That is, an ink level is measured using a sensor 30 mounted to the first storage part 11 so as to prevent the ink level from dropping below the second storage part 13, and the amount of ink being injected from the ink container is controlled accordingly.

The location of the sensor 30 for measuring an ink level is not specifically limited. For example, the sensor 30 may be mounted at the upper portion of the first storage part 11. The sensor 30 may include a first sensor 31 measuring the lower limit of the ink level in the first storage part 11, and a second sensor 32 measuring the upper limit thereof.

When the ink level in the first storage part 11 drops below the lower limit, the sensor 30 detects this reduction and causes ink to be supplied through the ink injection port 2. When ink in the first storage part 11 exceeds the upper limit, the sensor 30 detects this and causes ink supply to be stopped.

Although not shown, the sensor 30 measuring the ink level may be formed at the side portion of the first storage part 11.

As set forth above, in the inkjet head assembly according to exemplary embodiments of the invention, the ink tank, supplying ink to the inkjet head, stores ink separately in the first storage part and the second storage part thereof, and the second storage part maintains a full ink level. Accordingly, the inkjet head assembly can minimize deterioration in print quality due to the second storage part attenuating pressure variations caused by ink movement when the inkjet assembly moves.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head assembly comprising:
an ink tank including a first storage part receiving ink, and a second storage part communicating with the first storage part through at least one through hole and maintaining a full ink level upon receiving ink from the first storage part; and
an inkjet head connected to the second storage part by an ink supply path and ejecting ink upon receiving ink from the second storage part.

2. The inkjet head assembly of claim 1, wherein the through hole has a diameter ranging from 1 mm to 10 mm.

3. The inkjet head assembly of claim 1, wherein the second storage part has a volume of 10 cc or greater.

4. The inkjet head assembly of claim 1, wherein the ink supply path includes a filter.

5. The inkjet head assembly of claim 1, wherein the inkjet head includes an ink chamber temporarily storing ink supplied from the second storage part.

6. The inkjet head assembly of claim 1, wherein the inkjet head includes an inkjet path discharging ink supplied from the second storage part.

7. The inkjet head assembly of claim 1, wherein the first storage part includes a pneumonic port.

8. The inkjet head assembly of claim 1, wherein the first storage part includes an ink injection port.

9. The inkjet head assembly of claim 1, wherein the first storage part includes a sensor measuring an ink level.

10. The inkjet head assembly of claim 9, wherein the sensor is mounted to an upper portion or a side portion of the first storage part.

11. The inkjet head assembly of claim 9, wherein the sensor includes:
a first sensor measuring a lower limit of an ink level in the first storage part; and
a second sensor measuring an upper limit of the ink level in the first storage part.
